(19) United States
(12) Patent Application Publication
(10) Pub. No.: US 2014/0337127 A1
(43) Pub. Date: Nov. 13, 2014

(54) CLIENT BRIDGE

(71) Applicant: Brightcove, Inc., Boston, MA (US)

(72) Inventors: David Morel, Tempe, AZ (US); Troy Haas, Chandler, AZ (US); Albert J. McGowan, Tempe, AZ (US)

(73) Assignee: BRIGHTCOVE, INC., Boston, MA (US)

(21) Appl. No.: 14/341,674

(22) Filed: Jul. 25, 2014

Related U.S. Application Data
(63) Continuation-in-part of application No. 14/069,961, filed on Nov. 1, 2013.
(60) Provisional application No. 61/815,111, filed on Apr. 23, 2013.

(51) Int. Cl. G06Q 30/02; H04L 29/06

(52) U.S. Cl. CPC G06Q 30/0251; H04L 67/42
USPC 705/14.49

(57) ABSTRACT

Advertisement assets may be selected based on the capabilities of the device used to display or execute the advertisements. The capabilities of a device may be determined by a client bridge of an advertisement delivery system. The client bridge may analyze the capabilities and determine a set of advertisements that are compatible with the capabilities. The advertisement delivery system may select advertisements to maximize the advertisement yield within the bounds of the device capabilities.

### CROSS-REFERENCE TO RELATED APPLICATIONS

This application is a continuation-in-part to U.S. patent application Ser. No. 14/069,961, filed Nov. 1, 2013 which claims the benefit of U.S. Provisional Application No. 61/815,111, filed Apr. 23, 2013. Both applications are entitled “Live Ad Processing Engine Service (APES),” and both applications are hereby incorporated by reference in their entirety for all purposes.

### BACKGROUND OF THE INVENTION

The delivery of media over data networks such as the Internet is often supported with advertisements (“ads”). Advertisements are often inserted into media such as video streams, web content, games, and the like. Advertisements may be selected and inserted into the content as the content is provided to a user.

Advertisement marketplace can be unpredictable and dynamic. Advertisement marketplace may involve many different advertisers, broker services, advertisement formats, content, and the like. Delivery of advertisements to users may be further complicated by the large number of different user devices with different capabilities. User devices may have different rendering and processing capabilities that may be incompatible with some of the advertisements.

### BRIEF SUMMARY OF THE INVENTION

Techniques disclosed herein provide for selecting advertisement assets based on the capabilities of the device used to display or execute the advertisements. The capabilities of a device may be determined by a client bridge at an advertisement delivery system. An advertisement delivery system may analyze the capabilities and determine a set of advertisements that are compatible with the capabilities.

An example method of determining advertisement assets to transmit to a client according to the disclosure, includes receiving, via a data communication interface, advertisement assets from an advertisement provider, the advertisement assets may have different formats and encodings. The method may further include classifying the received advertisement assets into classification groups. Each classification group may include advertisement assets suitable for clients with specific display and processing capabilities. The method may also include receiving from the client a context of the client. The context may include the runtime environment, network conditions, or display capabilities of the client. The method may also include determining, from the context of the client, the client's capability for displaying and processing advertisement assets. The client's capability may include the display resolution or decoding capability. The method may also include selecting a classification group of advertisement assets. The classification group of advertisement assets may be selected at least in part based the client's determined capability for displaying and processing the advertisement assets. Advertisement asset from the selected classification group of advertisement assets may be transmitted to the client.

In some embodiments the advertisement asset transmitted to the client may be selected to increase advertisement yield. In some embodiments the method may further include reformatting advertisement assets for different classifications groups. The advertisement assets may be injected into a content stream delivered to the client and the assets may include video advertisements and video overlay advertisements. In some cases the method may also include creating, with a processing unit, a segment of video media with at least one advertisement asset. The advertisement asset may be selected at least in part based on the client's determined capability.

Embodiments include a server for determining advertisement assets to transmit to a client based on a client's capability for displaying and processing advertisement assets. The server may include a communications interface, a memory, and a processing unit coupled to the communications interface and the memory. The processing unit may be configured to cause the server to receive, via the communication interface, advertisement assets from an advertisement provider. The advertisement assets may have different formats and encodings. The processing unit may be configured to cause the server to classify the received advertisement asset into classification groups. Each classification group may include advertisement assets suitable for clients with specific display and processing capabilities. The server may receive from the client, via the communications interface, a context of the client. The context may include the runtime environment, network conditions, or display capabilities of the client. The server may be configured to further determine, from the context of the client, the client's capability for displaying and processing advertisement assets. The client's capability may include the display resolution or the decoding capability. The server may further be configured to select a classification group of advertisement assets. The classification group of advertisement assets may be selected at least in part based the client's determined capability for displaying and processing the advertisement assets. An advertisement asset from the selected classification group of advertisement assets may be transmitted to the client.

Embodiments also include a non-transitory, computer-readable medium having instructions embedded thereon for providing advertisement assets to a client via a data communications interface. The instructions, when executed by a computer, may cause the computer to perform functions including receiving, via the data communication interface, advertisement assets from an advertisement provider. The advertisement assets may have different formats and encodings. The instructions, when executed by a computer, may further cause the computer to classify the received advertisement asset into classification groups. Each classification group may include advertisement assets suitable for clients with specific display and processing capabilities. The instructions, when executed by a computer, may further cause the computer to receive from the client, via the data communications interface, a context of the client. The context may include the runtime environment, network conditions, or display capabilities. The instructions, when executed by a computer, may also cause the computer to determine, from the context of the client, a client's capability for displaying and processing advertisement assets. The client's capability may include the display resolution or decoding capability. The instructions, when executed by a computer, may cause the computer to select a classification group of advertisement assets. The classification group of advertisement assets may be selected at least in part based the client's determined capability for displaying and processing the advertisement assets.

### BRIEF DESCRIPTION OF THE DRAWINGS

The present disclosure is described in conjunction with the appended figures:

FIG. 1 is a block diagram illustrating a media servicing system, according to some embodiments of the present invention.

FIG. 2 is a functional block diagram illustrating a system configured to identify advertisements compatible with the capabilities of a device.

FIG. 3 is a functional block diagram shown data stored at the advertisement delivery system.

FIG. 4 is a swim-lane diagram illustrating example interactions between a device, advertisement delivery system, and ad servers.

FIG. 5 is a flow chart illustrating an example method of determining advertisement assets to transmit to a client based on a client's capability for displaying and processing the advertisement assets.

FIG. 6 illustrates an embodiment of a computer system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing various embodiments of the invention. It is understood that various changes may be made in the function and arrangement of elements without departing from the spirit and scope as set forth in the appended claims.

The terms “ad”, “advertisement”, and “advertisement assets” including alternate forms thereof, refer to marketing content distinct from user-requested media content. Although the techniques described herein discuss obtaining and providing advertising data, they also can be applied to data for content other than advertising, such as other on-demand content. Furthermore, although techniques described herein are often provided in the context of video streaming, they can be applied to other forms of media content (e.g., audio streaming) as well. A person of ordinary skill in the art will recognize many alternate applications.

A large portion of media (videos, music, web pages, etc.) available via the internet is ad-supported. Media content providers receive advertising revenue from media content, while often allowing end users to consume the media content free of charge. Advertisements may be inserted into the media or transmitted with the media. Advertisements may be dynamically selected and coupled with the media depending on a variety of factors related to user interests, time of day, content type, advertiser constraints, ad prices, and the like. An advertisement delivery system may be required to dynamically evaluate multiple factors, locate available advertisement that compliments the factors, and deliver the advertisement content to the user.

An additional aspect complicating the selection and delivery of advertisement to users stems from the large spectrum of different devices users may use to access the internet and the media content. Users may access media content using many different types of devices with different capabilities. Devices may have different processing, display, bandwidth and/or audio capabilities. Some devices may be unable to process and/or display all advertisement formats or types. For example, devices with limited processing capability may be unable to decode high definition video advertisements and may be limited to standard definition video advertisements. Devices, such as mobile smartphones or tablets may have limited screen sizes or resolutions which may make some font sizes or advertisement format difficult to see and may require advertisements with relatively large font sizes to be effective.

Software loaded or available on a device may also dictate the types or formats of advertisements that may be processed and/or displayed on a user's device. The user's device may be limited by a specific operating system, media player client and/or application, plug-ins, codecs, algorithms, and other software. In some cases, devices may have one or more software modules or plug-ins for receiving advertisement content from specific ad networks, or based on one or more specific technologies, encodings, or formats.

In many cases advertisement content may be formatted or altered to be compatible with the capabilities of a user's device. Advertisement content may be formatted for different screen sizes, encodings, font sizes, bandwidth requirements, and the like. Advertisement content may be formatted and available for different device capabilities. The advertisement content may be available and stored in different files for different user device capabilities. In embodiments advertisement delivery system may dynamically determine the capabilities of the user's device and determine the compatibility of available formats of an advertisement with the user's device. The advertisement content may be dynamically assembled from one or more different ad networks.

In embodiments, a user's device may require one or more advertisement content. Media content may have multiple advertisement slots that may be filled with advertisement content. Advertisement content for advertisement slots may be requested by the user's device from the advertisement delivery system. The advertisement delivery system may transfer advertisement content to the user's device based on the requests.

For example, a streaming video may be configured to play advertisement videos at the beginning of the video or at designated timeslots of the video. Additional advertisement slots may be associated with the video. Additional advertisements may include, for example, banner advertisements superimposed over the video, advertisements shown next to video media in a webpage or a video player. A user's device may request advertisements to fill the various advertisement slots.

In some cases, the user's device may be configured to determine the specific requirements of the advertisement content for each of the advertisement slots. The user's device may request specific advertisement characteristics based on its capabilities. The advertisement request from the user's device to the advertisement delivery system may limit the advertisements to specific ad networks, codecs, resolution, size, and the like.

In some embodiments, a user's device may include a client module for determining the capabilities of the device. The client module may be a software module and may be configured to determine the capabilities of a user's device. The client module may asses the hardware, software, network, and other capabilities of the user's device. The client module may report the capabilities of the device to a remote system configured to deliver advertisements to the device. An advertisement delivery system may analyze the reported capabilities of the device. The advertisement delivery system may keep track of the capabilities of the user's device.

In some embodiments, the capabilities of the user's device may be determined by the advertisement delivery system. The advertisement delivery system may include a client bridge. The client bridge may be a software module and may be configured to determine the capabilities of a user's device. The client bridge may asses the hardware, software, network, and other capabilities of the user's device. An advertisement delivery system may analyze the determined capabilities of the device. The advertisement delivery system may keep track of the capabilities of the user's device.

The client bridge of an advertisement delivery system may determine the capabilities of the user's device by analyzing the context of and environment of the user's device. The client bridge may determine or infer capabilities of the user device by analyzing interactions and communications between the device and the advertisement delivery system. The client bridge may capture and/or analyze responses, requests, and activity between the advertisement delivery system and the user device. The client bridge may analyze user device responses and requests and identify aspects or data in the responses that may be used to determine capabilities of the user's device. For example, a user's device ID or model ID of the device my often be sent with some advertisement requests from the device to the advertisement delivery system. The device ID or model ID may be used to identify the hardware capabilities of the device from a database of known devices. In some cases, the time of responses may indicate network performance parameters between the device and the advertisement delivery system.

In some embodiments, the client bridge may determine the capabilities of the user device with challenge requests. The client bridge may request specific information or request the processing of specific media or information. Based on the device's ability or inability to perform the task and the time the device may need to complete the task, the client bridge may determine the installed software, plugins, processing capability, and the like. For example, the client bridge may send a challenge to the device that includes an encoded file. The device may be requested to decode the file and send back an acknowledgement back to the client bridge upon successful completion of the task. If the device is can successfully decode the file the client bridge may identify the codecs and/or software installed on the device. Likewise, based on the time it may take to decode the file, the processing capabilities of the device may be estimated by the client bridge.

In embodiments, a user's device may request advertisements without specifying advertisement requirements. A user's device may request advertisements based only on the advertisement types or advertisement slots. The user's device may perform generic advertisement requests. The advertisement delivery system may determine the required or preferred advertisement format and characteristics based on the capabilities determined by the client bridge.

The client bridge may analyze the capabilities of the user device as reported by the client bridge, the requests for advertisements from the device, and available advertisement content from advertisement networks to determine suitable advertisements to deliver to the device. The advertisement delivery system may determine the optimum set of advertisements for the device to maximize the yield or improve the advertisement yield.

The advertisement delivery system may catalog and categorize available advertisement content from one or more different advertisement networks. The advertisements may be indexed based on their formats and characteristics. The advertisements may be indexed to allow efficient matching of the available advertisements with the reported device capabilities.

A client bridge may determine capabilities of the device. The capabilities may identify compatibility with one or more specific advertisement formats and identifying the processing capability of the device. The advertisement delivery system may analyze the capabilities to determine general advertisement formats and characteristics that may be compatible with the device. The advertisement delivery system may associate specific advertisement characteristics with the device. The advertisement delivery system may determine that ads from specific ad network may be compatible with the software loaded on the device. The advertisement delivery system may determine or calculate how many advertisements may be simultaneously loaded or executed by the device and/or what combinations of advertisement types and format may be executed by the device.

For example, a device with hardware support from four or more processing cores may be capable of simultaneously processing and displaying a high definition video and interactive features. Devices with slower hardware, less memory, or the like may be determined to only support one video advertisement and one or more additional picture advertisements, banner advertisements, or other advertisement format requiring lower hardware demands.

The advertisement delivery system may use one or more tables or reference guidelines to determine advertisement compatibility based on the capabilities identified by the client bridge. The guidelines may include predetermined estimates of hardware and/or software requirements for types of advertisements, advertisement formats, and/or the like. The predetermined estimates may include testing results of common processors, devices and software and may include data related to processor requirements, bandwidth requirements and the like.

Media processed or displayed by the user device may include advertisement slots. The user's device may request advertisements from the advertisement delivery system to fill the slots. A user's device may send a request that includes the type of available advertisement slots. The advertisement delivery system may use the previously determined device capabilities to determine a set of compatible advertisements to fill the slots. The advertisement delivery system may determine a set of advertisements to transmit to the user device to maximize or improve the advertisement yield. The advertisement delivery system may determine an appropriate combination of advertisement characteristics the available advertisement slots. The characteristics may be selected based on the capabilities of the device and selected to allow the device to display all of the advertisements in an adequate time and within the capabilities of the device. The advertisement delivery system may identify one or more possible combinations of advertisement types and advertisement characteristics that may be compatible with the capabilities of the device.

The advertisement delivery system may query its advertisement index or one or more advertisement networks for advertisements with the identified formats and characteristics. Based on the available advertisements the advertisement delivery system may prioritize and assemble a set of advertisements to fill the slots. The advertisements may be selected to comply with the capabilities of the device and improve of maximize the advertisement yield.

For example, a user device may request advertisements to fill three advertisement slots. The advertisement slots may include a video advertisement, a video overlay, and an additional advertisement that may be located next to the video advertisement. The device may send a request to the advertisement delivery system for the advertisements. The advertisement delivery system may, based at least in part on the determined/received capabilities of the device, determine characteristics and formats of advertisements appropriate for the slots. The advertisement delivery system may identify a range or several sets of possible compatible characteristics of advertisements for the slots that meet the capabilities of the device. Based on the capabilities, the advertisement delivery system may determine one set that includes a high definition video advertisement from ad network A, an overlay advertisement from ad network B, and a photo advertisement from ad network A may be suitable for the device's capabilities. In addition, the advertisement delivery system may determine that a second set that includes a standard definition video advertisement, an overlay advertisement, and a standard definition advertisement all from ad network C may also be suitable for the device's capabilities. Further still, a third set that includes only a super high definition video advertisement without any additional advertisement may also be compatible with the capabilities of the device.

The advertisement delivery system may query an advertisement index to identify available advertisements that match the formats and characteristics of the advertisements in the identified sets. In some cases the advertisement delivery system may query individual ad networks for the identified advertisements. In some cases the advertisement delivery system may include additional parameters with the query or advertisement request that includes genre, user interests, user information, information related to media content the advertisements are inserted into, and/or other criteria.

As a result of the query to the advertisement index and/or ad networks, a list of available advertisements with parameters and formats suitable for the user device may be received by the advertisement delivery system. Based on the available types and formats of advertisements, the system may determine if the available advertisements may be combined into one of the predetermined sets that will meet the capabilities of the device.

In some cases, the available advertisements may be used to fill the slots of one of the predetermined advertisement sets that meet the capabilities of the device. The advertisement delivery system may analyze the available advertisements and identify sets of advertisements that meet the capabilities of the device. In the case where more than on set may be assembled, the system may determine if one of the sets provides a higher advertisement yield. The advertisement yield may be determined based on how many advertisements make up each set. In some cases each advertisement slot may be assigned a rank or score. The rank and score may be determined based on the position, duration, size, timing, and/or other factors of the advertisement slot. For example, advertisement slots that are closer in position to the media the user is watching may be assigned a higher score than advertisement slots that are distant. The type of advertisement slot may also be assigned different scores. Advertisement slots for video may be assigned higher scores than slots for picture advertisements. Based on the filled slots, the type of advertisement in each slot an advertisement yield may be computed for each combination of compatible and available advertisements. The combination with the highest score may be selected.

In embodiments described herein the processing associated with identifying advertisements and determining combinations of advertisements suitable for a device may be performed at the advertisement delivery system. The advertisement delivery system may have larger processing capabilities and more up to date information regarding advertisement availability. The advertisement delivery system may have access to a variety of advertisement marketplaces, networks, and other sources. The availability of the sources may continuously or frequently change.

The client bridge may be responsible for identifying the capabilities of the device. In some embodiments, the client bridge may continuously, periodically, or as triggered by advertisement requests also update or determine current processing loads, memory usage, and/or activity of the device. Processor loads may be used refine or update the capabilities of the device for processing of advertisements. If a user has many other concurrent applications open and running, the ability of the device to process, decode, and display advertisements may be significantly lower than the hardware capabilities may suggest.

In embodiments, the client bridge may be an application, a plug-in, a hardware monitor, and/or other software or hardware loaded on a server and may be collocated with the advertisement delivery system.

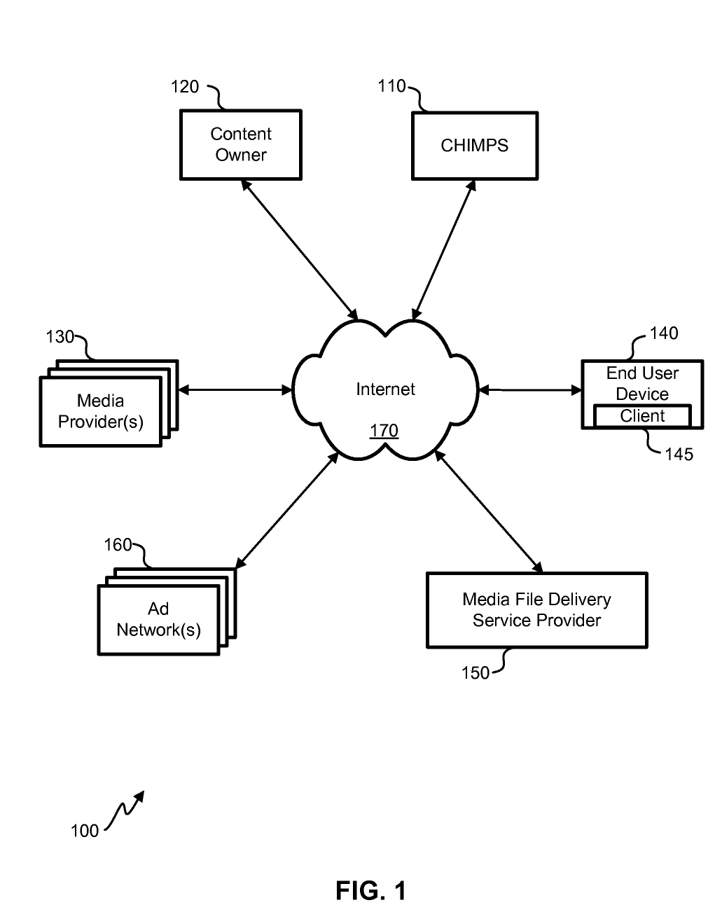

FIG. 1 is a block diagram illustrating a media servicing system 100, according to some embodiments. Advertisements are often stored and maintained separate from the primary media content. The distribution of ad-supported media via the Internet can therefore involve a variety of entities. The system may deliver media content to a client 145, executed by an end user device 140 providing media playback to an end user. The client 145 can be, for example, a media player, browser, or other application adapted to request and/or play media files. The media content can be provided via a network such as the Internet 170 and/or other data communications networks, such as a distribution network for television content. The end user device 140 can be one of any number of devices configured to receive media over the Internet 170, such as a mobile phone, tablet, personal computer, portable media device, set-top box, video game system, etc. Although only one client 145 and one end user device 140 are shown in FIG. 1, it will be understood that the media servicing system 100 can provide media to many (hundreds, thousands, millions, etc.) of clients 145 on many (hundreds, thousands, millions, etc.) of end user devices 140.

For on-demand content (e.g., requested media that is stored in its entirety), a media file provided by one or more media providers 130 can be processed and indexed by cloud-hosted integrated multi-node pipelining system (CHIMPS) 110. The media file may be stored on media file delivery service provider (MFDSP) 150, such as a content delivery network, media streaming service provider, cloud data services provider, or other third-party media file delivery service provider. Additionally or alternatively, the CHIMPS 110 may also be adapted to store the media file. On-demand content can be provided to the client 145 via progressive downloading and/or streaming.

For purposes of this disclosure, advertising content can be considered a form of on-demand content that is distributed much the same way. (As previously mentioned, techniques for interleaving live and on-demand content apply not only to inserting ads into live content, but can apply to inserting any form of on-demand content, including non-advertisement content as well.) Rather than media providers, however, ad content can come from ad networks 160. Furthermore, the ad networks 160 may determine what ads to provide at a given point in time for a given client 145 by implementing business rules.

Both on-demand and live content can utilize any of a variety of forms of streaming media. One such method is chunk-based media streaming in which a media file or live stream is processed into smaller chunks and stored (e.g., in a server of the CHIMPS 110 or Media File Delivery Service Provider 150) for serving to a client 145. The client 145 can make a URL request to the CHIMPS 110, which can provide a manifest file (also known as an index file) indicating the locations of each of the chunks of media using, for example, Uniform Resource Indicators (URIs) (e.g., Universal Resource Locators (URLs)) or other indicators. The client 145 can then use the information in the manifest file to stream the media content, following one location after the other to download each chunk of media. The client may sequentially request and receive multiple manifest files to stream requested media content. This is especially true for live media, where the live stream might still be received and processed by the CHIMPS 110 when the client makes the request for the manifest file. Additional detail regarding such chunking and indexing, as well as techniques for dynamically creating chunks and manifest files, can be found in U.S. Pat. No. 8,327,013 entitled “Dynamic Index File Creation for Media Streaming” and U.S. Pat. No. 8,145,782, entitled “Dynamic Chunking For Media Streaming,” both of which are incorporated by reference herein in their entirety.

The CHIMPS 110 can further manage the processing and syndication of media (live or on-demand) received from the media provider(s) 130. For example, the CHIMPS 110 can provide transcoding and other services to enable media provided by the media provider(s) to be distributed in a variety of formats to a variety of different device types in a variety of locations. Furthermore, the CHIMPS 110 provide feedback to the media provider(s) 130 regarding the media's syndication, including user behavior during media playback. For example, the CHIMPS 110 can provide a media provider 130 with information indicating that end users tend to stop watching a video at a certain point in playback, or that users tend to follow links associated with certain advertisements displayed during playback. With this data, media provider(s) 130 can adjust factors such as media content, advertisement placement and content, etc., to increase revenue associated with the media content and provide the end user device 140 with a more desirable playback experience. Additionally or alternatively, the CHIMPS 110 can dynamically provide a customized playback experience on the end user device 140 according to aspects of the context associated with the content at the time of the request, aspects of the content request itself, or both. It can be noted that although embodiments herein may utilize media files and live streams explicitly, other embodiments may utilized other forms of media assets, such as dynamic web pages, and may incorporate multiple media elements, including players, user interface components, user controls and control components, images, and other media content, objects, or types. Additionally, it can be noted that various functions, operations, processes, or other aspects that are described in this example, and other examples, as being performed by or attributable to the CHIMPS 110 can be performed by another system operating in conjunction with the CHIMPS 110, loosely or tightly synchronized with the CHIMPS 110, or independently; for example, collecting data from other digital services to be combined and reported with data collected by the CHIMPS 110 can, in some implementations, be performed by a system other than the CHIMPS 110. Additional detail regarding the functionality of the CHIMPS 110 can be found in in U.S. Pat. No. 8,301,733, entitled “Dynamic Chunking for Delivery Instances,” which is incorporated by reference herein in its entirety.

A content owner 120 can utilize one or more media provider(s) 130 to distribute media content owned by the content owner 120. For example, a content owner 120 could be a movie studio that licenses distribution of certain media through various media providers 130 such as television networks, Internet media streaming websites and other on-demand media providers, media conglomerates, and the like. In some configurations, the content owner 120 also can operate as a media provider 130.

Different ad networks 160 often provide advertisement data to a client 145 in a proprietary language and/or format. Because it can be costly and time consuming to develop a client 145 using an SDK of a particular ad network 160, media provider(s) 130 and/or other entities that create clients 145 for media playback find it difficult to access advertisements from other ad networks 160. Furthermore, clients 145 may need to be updated whenever the ad network 160 for which the client was programmed makes any adjustments in its proprietary language and/or format. Some clients may allow for plugins to be utilized by an existing client 145 to communicate with different ad networks 160. However, it can still be time consuming and costly to separately integrate each of these plugins into a client 145. Problematically, many ad networks 160 are unable to fulfill the needs of a media provider 130 on their own. Thus, many media provider(s) and/or other entities that create clients 145 for media playback are forced to adapt their clients 145 to communicate with multiple ad networks 160 to fill up the allotted time slots for advertisements.

Advertisements may be inserted directly into content consumed by the client, depending on the streaming techniques utilized. In such cases, a Live Advertising Processing Engine Service (APES) can be utilized to provide the client with advanced functionality for advertising during the consumption of live content by a client. Additional details regarding Live APES can be can be found in in U.S. patent application Ser. No. 14/069,961 entitled “Live Advertising Processing Engine Service,” which is incorporated by reference herein in its entirety.

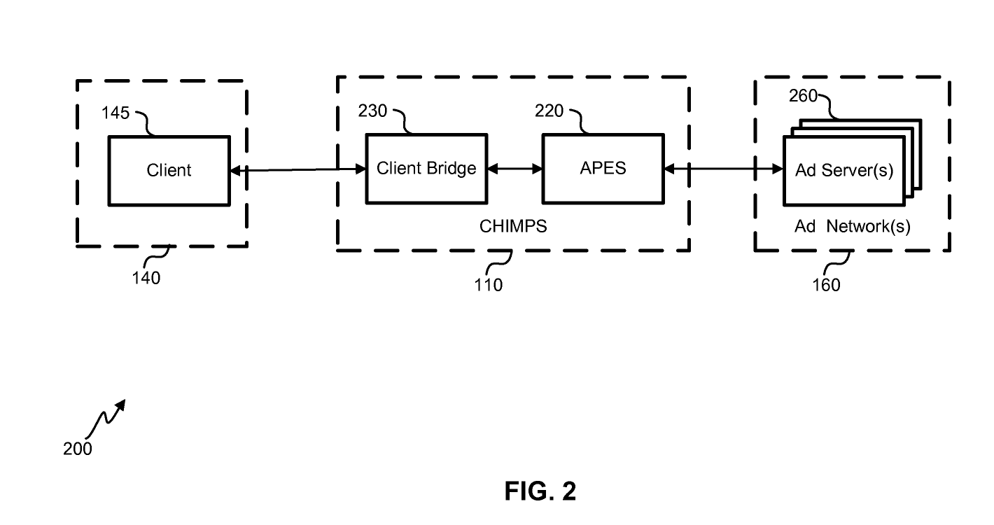

Techniques provided herein may utilize an Advertising Processing Engine Service (APES). FIG. 2 is a simplified block diagram illustrating a system 200 utilizing an APES 220, according to a first embodiment. The system 200 can comprise a user device 140 that includes a client 145. Advertisement delivery system that may include a client bridge 230, APES 220, and one or more ad servers 260. As shown, these components can be incorporated into larger systems, such as the end user device 140, CHIMPS 110, and/or advertising network(s) 160 as shown in FIG. 1. In other embodiments, however, the APES 220, client bridge 230, and/or other components may be incorporated differently into a larger system and/or may be stand-alone components. Furthermore, other embodiments may combine, separate, add, omit, substitute, and/or modify components of the system 200, while providing the same overall functionality as described herein.

The client 145 can interface with the client bridge 230 to retrieve media and/or advertisement data, as well as access any other services of the CHIMPS 110. Accordingly, the client 145 need only be programmed for the routines, data structures, object classes, variables, etc. of the client bridge 230, without being specially tailored to accommodate interaction with a particular ad network 160.

The client bridge 230 may interact with the client 145 to determine the capabilities of the client 145. The client bridge 230 may determine the hardware capabilities and/or software capabilities of the client 145. The client bridge 230 may determine other information about the environment of the client 145 and the user's device 140 that may include location, network conditions, and/or the like. The client bridge 230 may transmit information about the user's device 140 to the APES 220.

In some embodiments, the client bridge may be configured to identify characteristics of advertisements compatible with the device. The client bridge 230, based on the determined capabilities of the user device and the advertisement requests from the client 145, may determine characteristics of advertisements for the client 145. The client bridge 230 can determine characteristics and formats of the advertisements that are best suited or compatible with the user device 140. The client bridge 230 may generate one or more sets or groups of possible combinations of advertisements that are compatible with the capabilities of the user device. The client bridge 230 can determine the number of advertisements needed (ad count), duration of each, and other data to provide in a call to the APES 220, such as metadata for the requested media item, information from the client, custom parameters for client configuration, and the like. The client bridge can make a call to the APES 220 with the request.

In some embodiments, the APES 220 may be configured to identify characteristics of advertisements compatible with the device based on the capabilities of the user device reported by the client bridge. The client bridge may relay the client capability information to APES 220. APES 220, based on the determined capabilities of the user device and the advertisement requests from the client 145, may determine characteristics of advertisements for the client 145. APES 220 can determine characteristics and formats of the advertisements that are best suited or compatible with the user device 140 and may generate one or more sets or groups of possible combinations of advertisements that are compatible with the capabilities of the user device. The APES 220 can determine the number of advertisements needed (ad count), duration of each, and other data.

The APES may determine which ad network(s) 160 are to be used with which time slots. It can then make the call(s) to one or more ad server(s) 260 of the ad network(s) 160 involved, requesting the relevant advertisement data for each advertisement needed. Importantly, the APES 220 can make the call(s) using the format required by each of the ad network(s) 160, passing along information that the ad network(s) 160 might need to provide the proper advertisements (for example, in accordance with agreements between the ad network(s) 160 and media provider(s) 130). Such information could include, for example, geographical data related to the location of the client 145, data (title, duration, genre, etc.) regarding the media content requested by the client, the format, encoding, size, resolution requirements, and the like.

In response to the request from the APES 220, the ad server(s) may provide advertisement data for use in the playback of the media content. The advertisement data may be used by APES to determine one or more sets of available advertisements that are compatible and suitable for the user device 140. The advertisement data can include information enabling the advertisements to be incorporated into the playback of the media content, such as a URL of the advertisement, one or more accompanying tracking URLs, and other information. The CHIMPS 110 and/or other systems can utilize the advertisement data to seamlessly incorporate advertisements into a video stream provided to a client 145 using dynamic chunking and indexing processes, which are disclosed in U.S. Pat. No. 8,301,733 entitled “Dynamic Chunking for Delivery Instances” and U.S. Pat. No. 8,145,782, entitled “Dynamic Chunking For Media Streaming,” both of which are incorporated by reference herein in their entirety.

Upon receiving advertisement data back from the ad network(s) 160, the APES can then reformat the data into a standard format. For example, the APES 220 can create objects for from the advertisement data and pass the objects to the client bridge. The client bridge can then utilize the advertisement data to include along with any other data necessary (which may be provided by other components (not shown), internal or external, to the CHIMPS 110) to respond to the client's request for media content. Providing, for example, a one or more URL(s) of video content having the incorporated advertisement(s).

Because the APES 220 acts as an intermediary between the client 145 and the ad network(s) 160, the client 145 does not need to be specially configured to communicate with particular ad networks 160. Instead, the client 145 need only be able to communicate with the client bridge.

It can be noted that each of the components of the system 200 can implement different business rules to provide advertisement data that comports with the requests of media provider(s) 130, content owners 120, and/or other stakeholders. Moreover, the client bridge 230 can pass along information, provided in a request from the client 145, to the APES 220 that may include contextual and/or other data to inform business rules executed by the APES 220. Similarly, the APES 220 may pass along information that may inform business rules executed by the ad network(s) 160. Such information can include information provided in the original request from the client 145, and/or subsequently added by another component. In some embodiments, the request from the client 145 can not only inform business rules, but also provide new business rules to be implemented by the client bridge 230, APES 220, and/or ad network(s) 160.

The functionality provided by the APES 220 can be utilized in systems that may not involve the CHIMPS 110. In embodiments, the client 145, may determine what advertising data is needed and may directly a request to the APES 220. The APES 220 can provide the advertisement data directly to the client 145 without passing through the client bridge 230. The functionality of the APES 220 can be utilized in a variety of embodiments in which advertising data related to media content is desired. As described above, the APES 220 can be particularly beneficial when advertisement data multiple ad networks 160 is desired.

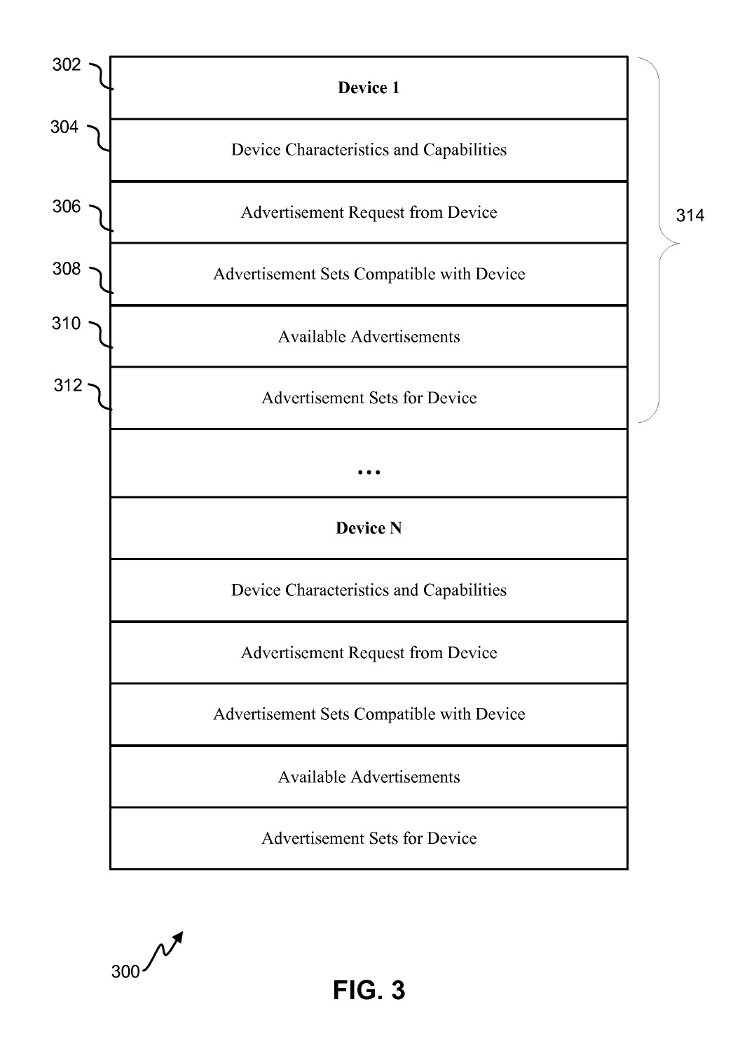

FIG. 3 is a simplified representation of data 300 that can be stored at the client bridge 230 of the advertisement delivery system 110, according to one embodiment, enabling the system to provide advertisements to the device 140 that meet the capabilities of the device and may optimize the advertisement yield. In the embodiment shown in FIG. 3, the data 300 includes plurality of devices that request advertisement data using the system 110. In embodiments, separate data records may be maintained for each device.

A record 314 of the data 300 may include a field 302 that identifies the device. The Device field 302 may include MAC data, IP address, or other unique identifying data related to the device. A record 314 may also include a field 304 with data related to the device characteristics and capabilities. The characteristics and capabilities of the device as determined by the client bridge may be stored in the field 304. Hardware capabilities, software capabilities, network characteristics and other data may be stored in the field. A record 314 may further include a field 306 that includes the advertisement request from the user's device. The field 306 may store data related to the advertisement slots the device may request to be filled. It may include information related to the format of the requested advertisement (e.g. video, banner, overlay) and other related information. A record 314 may also include a field 308 with data related to the calculated or identified advertisement types or characteristics that are compatible with the device. The field 314 may include one or more possible combinations of advertisement types and format that may be compatible with the capabilities of the device. Field 310 may include a list of available advertisements after the advertisement delivery system performs a query for advertisements. Field 312 may include data related to the final advertisement set or sets that are determine compatible of suitable for the device. The field 312 may include data related to a subset of the identified available advertisements in field 312.

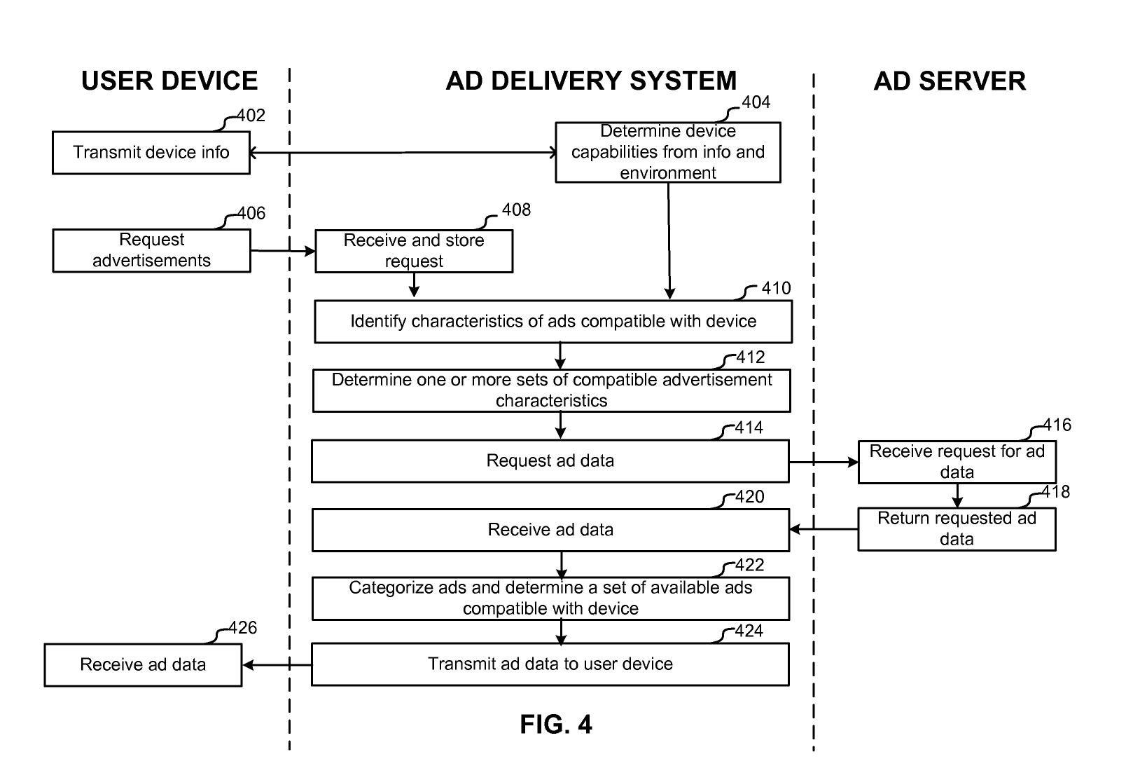

FIG. 4 is a swim-lane diagram illustrating how various components described herein can interact to provide a user device with advertisements in one embodiment. The user device 140, advertisement delivery system 110 can be configured in the manner shown in FIG. 2, for example. At block 402, the device 140 may send and receive data/requests from the client bridge of the advertisement delivery system. The communication between the device and the client bridge may be analyzed by the client bridge in block 404 and used to determine the capabilities of the device. The determined capabilities may be may be stored in the advertisement delivery system. Concurrently or at a later time, at block 406 the device may transmit advertisement requests to the ad delivery system. The advertisement request may identify advertisement slots that need to be filled with advertisements. The request along with the types of advertisement slots and their characteristics maybe received and stored by the advertisement system in block 408. Using the advertisement request and the information about the device the advertisement delivery system may identify characteristics of ads that may be compatible with the advertisement slots and the capabilities of the device in block 410. In block 412 the advertisement delivery system may determine one or more set of advertisement characteristics that may be used to fill the advertisement slots.

In block 414, the advertisement delivery system may request ad data from the ad networks and ad servers. The request may be for advertisements with characteristics and formats that may be used to fill the identified set of advertisements that have been determined to be compatible with the device capabilities. In bloc 416 the ad server may query available advertisements and in block 418 return data related to the available advertisement assets that match the characteristics. In block 420, the advertisement delivery system may receive the advertisement data for the available advertisements. The data may include information about the format, size, encoding, processor and memory requirements, and the like. In block 422 the received available ads may be categorized based on formats and characteristics and used to determine if the ads may be used to fill one or more of the sets of possible advertisements determined in block 412. If the available advertisements may be assembled into a compatible set the advertisement data of a compatible set may be sent to the user device in block 424. In block 426 the user device may use the data to directly request the advertisements. In some cases the data may include the advertisements.

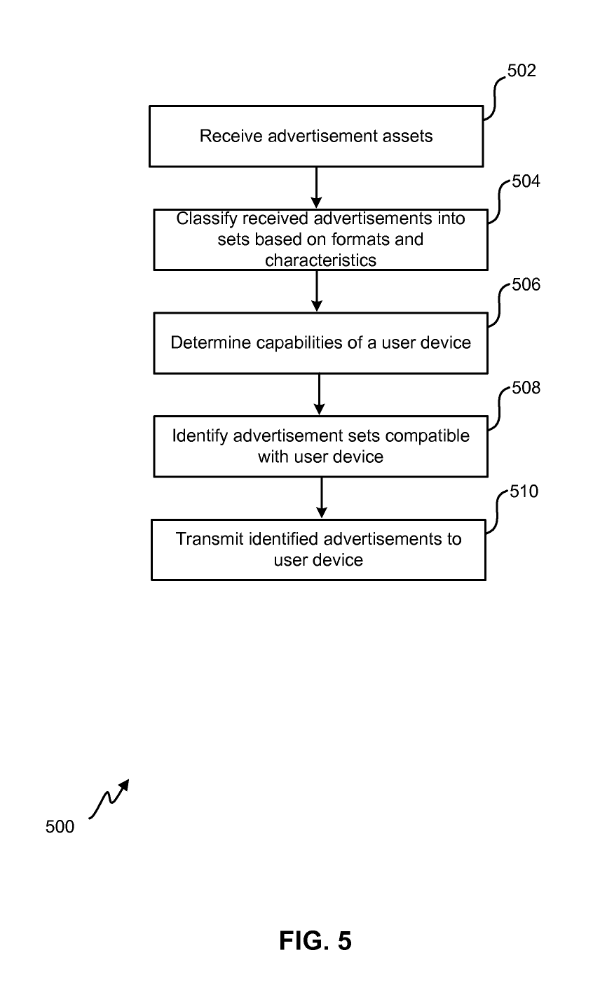

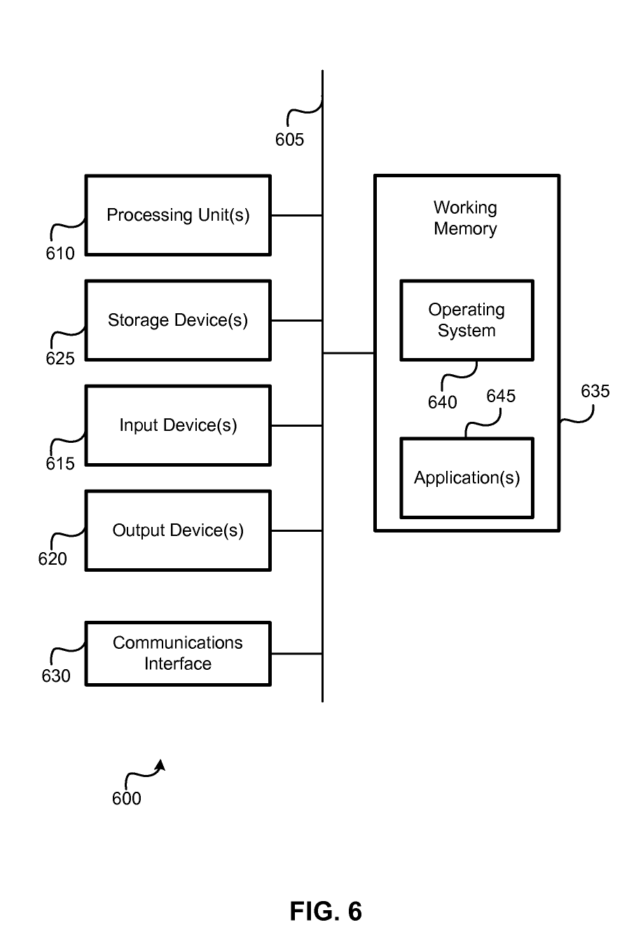

FIG. 5 is a simplified flow chart illustrating a method 500 of determining advertisement assets to transmit to a client based on a client's capability for displaying and processing the advertisement assets. The process 500 can be implemented, for example, by the system shown in FIG. 2. As with all other figures provided herein, FIG. 5 is provided as an example and is not limiting. Various blocks may be combined, separated, and/or otherwise modified, depending on desired functionality. Furthermore, different blocks may be executed by different components of a system and/or different systems. Such systems can include the computer system, described herein below with regard to FIG. 6.

At block 502, an advertisement delivery system may receive advertisement data from an advertisement server or network. The advertisements may have a variety of formats, encodings, characteristics, and the like. In block 504 the received advertisements may be classified into groups or sets that may be compatible with a user device or client with certain capabilities. The advertisements may be grouped according to the runtime environment, the network conditions, display capabilities, hardware capabilities, and/or the like. In block 506 the capabilities of the user device or client may be determined. The capabilities may be determined by a client bridge by analyzing the context and environment of the device. The capabilities of the client may include the hardware of the device, the loaded software, decoding capability, display resolution, network activity, and the like.

In block 508 one or more advertisement sets may be identified as compatible with the capabilities of the device and in block 510 the identified advertisements may be transmitted to the user device. The selected advertisements may be selected to improve advertisement yield, or the number of advertisements that may be consumed by a user associated with the device.

FIG. 6 illustrates an embodiment of a computer system 600, which may be configured to execute various components described herein using any combination of hardware and/or software. For example, one or more computer systems 600 can be configured to execute components of the advertisement delivery system 110 of FIG. 2. FIG. 6 provides a schematic illustration of one embodiment of a computer system 600 that can perform the methods provided by various other embodiments, such as the methods described in relation to FIGS. 4-5. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different physical locations.

The computer system 600 is shown comprising hardware elements that can be electrically coupled via a bus 605 (or may otherwise be in communication, as appropriate). The hardware elements may include processing unit(s) 610, which can include without limitation one or more general-purpose processors, one or more special-purpose processors (such as digital signal processors, graphics acceleration processors, and/or the like), and/or other processing structure, which can be configured to perform one or more of the methods described herein, including the methods described in relation to FIGS. 4-5, by, for example, executing commands stored in a memory. The computer system 600 also can include one or more input devices 615, which can include without limitation a mouse, a keyboard, and/or the like; and one or more output devices 620, which can include without limitation a display device, a printer, and/or the like.

The computer system 600 may further include (and/or be in communication with) one or more non-transitory storage devices 625, which can comprise, without limitation, local and/or network accessible storage. This can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 can also include a communications interface 630, which can include wireless and wired communication technologies. Accordingly, the communications interface can include a modem, a network card (wireless or wired), an infrared communication device, a wireless communication device, and/or a chipset (such as a Bluetooth™ device, an IEEE 802.11 device, an IEEE 802.15.4 device, a WiFi device, a WiMax device, cellular communication facilities, UWB interface, etc.), and/or the like. The communications interface 630 can therefore permit the computer system 600 to be exchanged with other devices and components of a network.

In many embodiments, the computer system 600 will further comprise a working memory 635, which can include a RAM or ROM device, as described above. Software elements, shown as being located within the working memory 635, can include an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above, such as the methods described in relation to FIGS. 5-7, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processing unit(s) 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processing unit(s) 610 to perform one or more procedures of the methods described herein. Additionally or alternatively, portions of the methods described herein may be executed through specialized hardware.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of if used to associate a list, such as A, B, or C, can be interpreted to mean any combination of A, B, and/or C, such as A, AB, AA, AAB, AABBCCC, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of determining advertisement assets to transmit to a client based on a client's capability for displaying and processing the advertisement assets, the method comprising:
receiving, via a data communication interface, advertisement assets from an advertisement provider, the advertisement assets having different formats and encodings;
classifying the received advertisement assets into classification groups, wherein each classification group includes advertisement assets suitable for clients with specific display and processing capabilities; receiving from the client, via the data communications interface, a context of the client, the context including at least one of:
runtime environment,
network conditions, or
display capabilities;
determining, from the context of the client, the client's capability for displaying and processing advertisement assets, wherein the client's capability includes at least one of:
display resolution, or
decoding capability;
selecting a classification group of advertisement assets, the classification group of advertisement assets selected at least in part based the client's determined capability for displaying and processing the advertisement assets; and
transmitting an advertisement asset from the selected classification group of advertisement assets to the client.

2. The method of claim 1, wherein the advertisement asset transmitted to the client is selected to increase advertisement yield.

3. The method of claim 1, further comprising reformatting advertisement assets for different classifications groups.

4. The method of claim 3, wherein the advertisement assets are injected into a content stream delivered to the client.

5. The method of claim 4, wherein the advertisement assets include video advertisements.

6. The method of claim 4, wherein the advertisement assets include video overlay advertisements.

7. The method of claim 4, further comprising creating, with a processing unit, a segment of video media with at least one advertisement asset, wherein the advertisement asset is selected at least in part based on the client's determined capability.

8. A server for determining advertisement assets to transmit to a client based on a client's capability for displaying and processing advertisement assets, the server comprising:
a communications interface;
a memory; and
a processing unit coupled to the communications interface and the memory, the processing unit configured to cause the server to:
receive, via the communication interface, advertisement assets from an advertisement provider, the advertisement assets having different formats and encodings;
classify the received advertisement asset into classification groups, wherein each classification group includes advertisement assets suitable for clients with specific display and processing capabilities;
receive from the client, via the communications interface, a context of the client, the context including at least one of:
runtime environment,
network conditions, or
display capabilities;
determine, from the context of the client, the client's capability for displaying and processing advertisement assets, wherein the client's capability includes at least one of:
display resolution, or
decoding capability;
select a classification group of advertisement assets, the classification group of advertisement assets selected at least in part based the client's determined capability for displaying and processing the advertisement assets; and
transmit, via the communication interface, an advertisement asset from the selected classification group of advertisement assets to the client.

9. The server of claim 8, wherein the advertisement asset transmitted to the client is selected to increase advertisement yield.

10. The server of claim 8, wherein the processing unit is further configured to reformat advertisement assets for different classification groups.

11. The server of claim 10, wherein the advertisement assets are injected into a content stream delivered to the client.

12. The server of claim 10, wherein the advertisement assets include video advertisements.

13. The server of claim 10, wherein the advertisement assets include video overlay advertisements.

14. The server of claim 11, wherein the processing unit is further configured to create a segment of video media with at least one advertisement asset, wherein the advertisement asset is selected at least in part based on the client's determined capability.

15. A non-transitory, computer-readable medium having instructions embedded thereon for providing advertisement assets to a client via a data communications interface, the instructions, when executed by a computer, cause the computer to perform functions including:
receiving, via the data communication interface, advertisement assets from an advertisement provider, the advertisement assets having different formats and encodings;
classifying the received advertisement asset into classification groups, wherein each classification group includes advertisement assets suitable for clients with specific display and processing capabilities;
receiving from the client, via the data communications interface, a context of the client, the context including at least one of:
runtime environment,
network conditions, or
display capabilities;
determining, from the context of the client, a client's capability for displaying and processing advertisement assets, wherein the client's capability includes at least one of:
display resolution, or
decoding capability;
selecting a classification group of advertisement assets, the classification group of advertisement assets selected at least in part based the client's determined capability for displaying and processing the advertisement assets; and
transmitting an advertisement asset from the selected classification group of advertisement assets to the client.

16. The non-transitory, computer-readable medium having instructions embedded thereon for providing advertisement assets to the client via the data communications network of claim 15, wherein the advertisement asset transmitted to the client is selected to increase advertisement yield.

17. The non-transitory, computer-readable medium having instructions embedded thereon for providing advertisement assets to the client via the data communications network of claim 16, wherein the advertisement assets are injected into a content stream delivered to the client.

18. The non-transitory, computer-readable medium having instructions embedded thereon for providing advertisement assets to the client via the data communications network of claim 17, wherein the advertisement assets include video advertisements.

19. The non-transitory, computer-readable medium having instructions embedded thereon for providing advertisement assets to the client via the data communications network of claim 17, wherein the advertisement assets include video overlay advertisements.

20. The non-transitory, computer-readable medium having instructions embedded thereon for providing advertisement assets to the client via the data communications network of claim 17, further comprising instructions for causing the computer to create, with a processing unit, a segment of video media with at least one advertisement asset, wherein the advertisement asset is selected at least in part based on the client's determined capability.
